(19) United States
(12) Patent Application Publication
(10) Pub. No.: US 2010/0034069 A1
(43) Pub. Date: Feb. 11, 2010

(54) METHOD FOR CONTROLLING FOCUS LOOP OF AN OPTICAL STORAGE DEVICE

(76) Inventors: Chih-Ching Yu, Hsinchu City (TW); Yu-Chun Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/188,219

(22) Filed: Aug. 8, 2008

(51) Int. Cl. G11B 7/00

(52) U.S. Cl. 369/53.23; G9B/7

(57) ABSTRACT

A method for controlling focus loop of an optical storage device includes: moving a lens of an optical pick-up head in a first moving direction; performing a focusing operation when a first S-curve sequence appears in a focus error signal; and when a light beam generated from the optical pick-up head is not focused on an optical disc, performing the focusing operation when a second S-curve sequence appears in the focus error signal; wherein the first S-curve sequence and the second S-curve sequence appear in the focus error signal during one revolution of the optical disc.

### BACKGROUND

The present invention relates to an optical storage device, and more particularly, to a method for controlling focus loop of an optical storage device.

The focus servo of an optical storage device may undergo vertical deviation during reading/writing operations if the thickness of the optical disc is non-uniform or the mechanism on which the optical disc is put is not level. When an optical pick-up head performs a focusing operation on a disc under vertical deviation, a light beam generated from the optical pick-up head is difficult to be correctly focused on the disc due to a higher relative velocity between a lens of the optical pick-up head and the disc. In particular, in a high density optical storage device, a smaller depth of focus will increase the difficulty of the focusing operation.

Generally, a representation (A+C)−(B+D) serves as a focusing error (FE) signal, where A, B, C, D are the outputs of the photo detector integrated circuit (PDIC). When a focal point of the lens approaches the optical disc, the intensity of (A+C) is greater than the intensity of (B+D), and the FE signal has a positive amplitude; when the focal point is precisely on the optical disc, the intensity of (A+C) is equal to the intensity of (B+D), and the FE signal has a zero amplitude; when the focal point of the lens moves away from the optical disc, the intensity of (A+C) is less than the intensity of (B+D), and the FE signal has a negative amplitude; when the focal point of the lens is far away from the optical disc, the intensities of (A+C) and (B+D) are zero. Therefore, when an optical pick-up head performs the focusing operation on the disc, a S-curve will appear in the FE signal.

FIG. 1A is a diagram illustrating one revolution of a disc under vertical deviation according to the related art. FIG. 1B is a diagram illustrating a focusing operation on a disc under vertical deviation shown in FIG. 1A. As shown in FIG. 1B, a curve 110 represents a vertical position of a light spot on a disc under vertical deviation, where points A and C respectively represent a highest and a lowest vertical position on the disc (case A and case C shown in FIG. 1A) and points B and D represent a middle vertical position on the disc (case B and case D shown in FIG. 1A); a line 120 represents a position of a focal point when the lens of the optical pick-up head is at the initial position; and line 130 represents a track of the focal point when the lens is moved toward the disc. When the optical storage device starts to perform the focusing operation on the disc, the lens of the optical pick-up head is moved from an initial position toward the disc, and the focusing operation is enabled when a first S-curve appears in a focus error (FE) signal. As shown in FIG. 1B, the first S-curve always appears in the FE signal during a period from the point B to the point C. Unfortunately, at this period a relative velocity between the lens and the disc is much higher, and the focusing operation will easily fail.

### SUMMARY OF THE INVENTION

It is therefore one of the objectives of the claimed invention to provide methods for performing the focusing operation while a smaller relative velocity exists between the lens and the disc, to solve the above-mentioned problems.

According to one embodiment of the present invention, a method for controlling focus loop of an optical storage device comprises: moving a lens of an optical pick-up head in a first moving direction; performing a focusing operation when a first S-curve sequence appears in a focus error signal; and when a light beam generated from the optical pick-up head is not focused on an optical disc, performing the focusing operation when a second S-curve sequence appears in the focus error signal; wherein the first S-curve sequence and the second S-curve sequence appears in the focus error signal during one revolution of the optical disc.

According to another embodiment of the present invention, a method for controlling focus loop of an optical storage device comprises: determining whether an optical disc is under vertical deviation or not; moving a lens of an optical pick-up head; when the optical disc is not under vertical deviation, performing a focusing operation when a first S-curve sequence appears in a focus error signal; and when the optical disc is under vertical deviation, performing the focusing operation when a second S-curve sequence appears in the focus error signal, wherein the first S-curve sequence appears prior to the second S-curve sequence; wherein the first S-curve sequence and the second S-curve sequence appears in the focus error signal during one revolution of the optical disc.

According to another embodiment of the present invention, a method for controlling focus loop of an optical storage device comprises: moving a lens of an optical pick-up head; not performing a focusing operation when a first S-curve sequence appears in a focus error signal; and performing the focusing operation when a second S-curve sequence appears in the focus error signal, wherein the first S-curve sequence appears prior to the second S-curve sequence, and the first S-curve sequence and the second S-curve sequence appears in the focus error signal during one revolution of the optical disc.

According to another embodiment of the present invention, a method for controlling focus loop of an optical storage device comprises: moving a lens of an optical pick-up head in a first moving direction, thereby making a focus error signal having a plurality of S-curve sequences appear therein; selecting a specific S-curve sequence among the plurality of S-curve sequences; moving the lens of the optical pick-up head in a second moving direction opposite to the first moving direction, and then moving the lens of the optical pick-up head in the first moving direction again; and performing a focusing operation when the specific S-curve sequence appears in the focus error signal.

According to another embodiment of the present invention, a method for controlling focus loop of an optical storage device comprises: moving a lens of an optical pick-up head; detecting a relative velocity between the lens and an optical disc; and performing a focusing operation when the relative velocity is slower than a predetermined value and an S-curve sequence appears in an focus error signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating one revolution of a disc under vertical deviation according to the related art.

FIG. 1B is a diagram illustrating a focusing operation on a disc under vertical deviation shown in FIG. 1A.

FIG. 2 is a diagram illustrating a focusing operation on a disc under vertical deviation according to one embodiment of the present invention.

FIG. 3 is a diagram illustrating a focus error signal when a focal point of a lens of an optical pick-up head is moved toward an optical disc.

FIG. 4 is a flowchart of controlling focus loop of an optical storage device according to a first embodiment of the present invention.

FIG. 5 is a flowchart of controlling focus loop of an optical storage device according to a second embodiment of the present invention.

FIG. 6 is a flowchart of controlling focus loop of an optical storage device according to a third embodiment of the present invention.

FIG. 7 is a flowchart of controlling focus loop of an optical storage device according to a fourth embodiment of the present invention.

FIG. 8 is a diagram illustrating S-curve sequences in the FE signal.

FIG. 9 is a flowchart of controlling focus loop of an optical storage device according to a fifth embodiment of the present invention.

### DETAILED DESCRIPTION

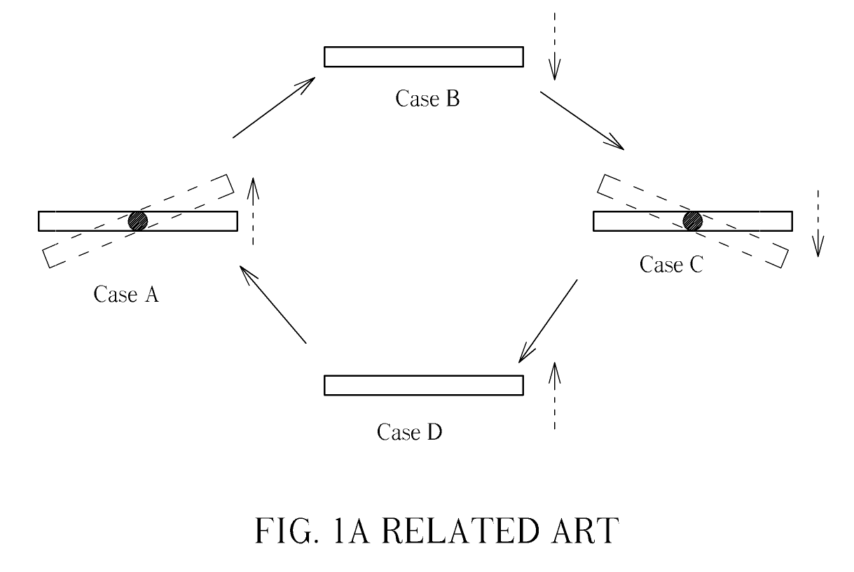

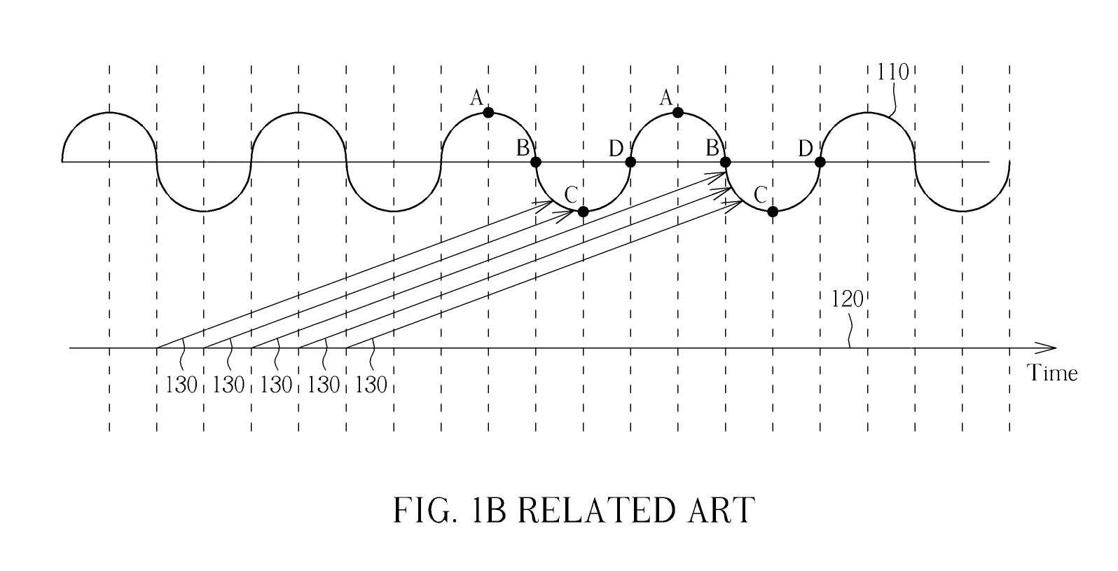

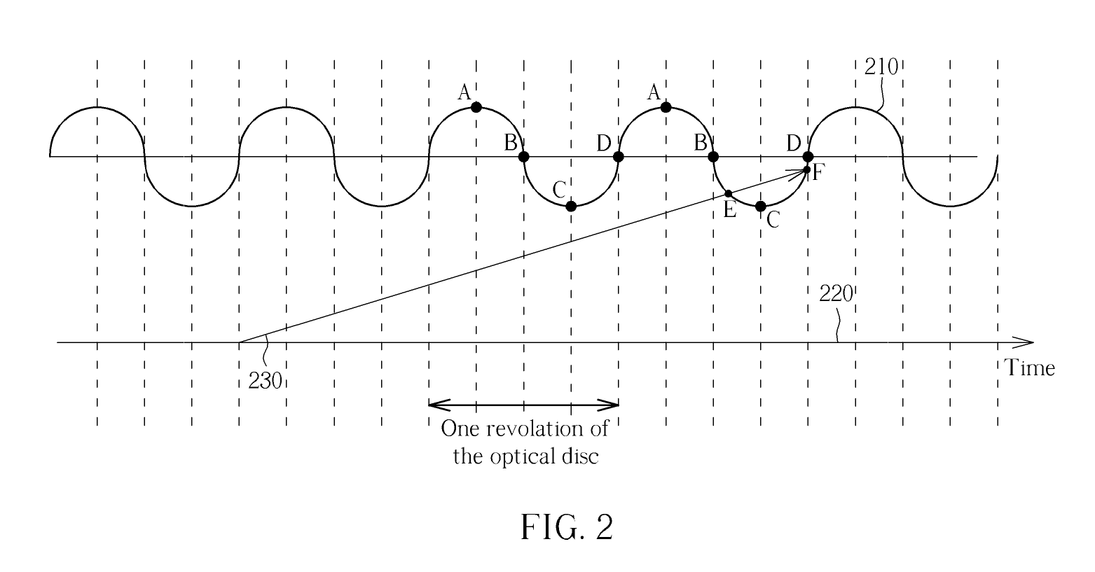

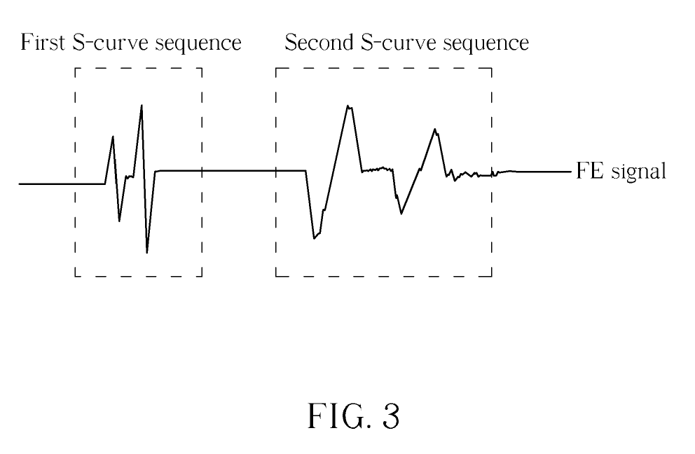

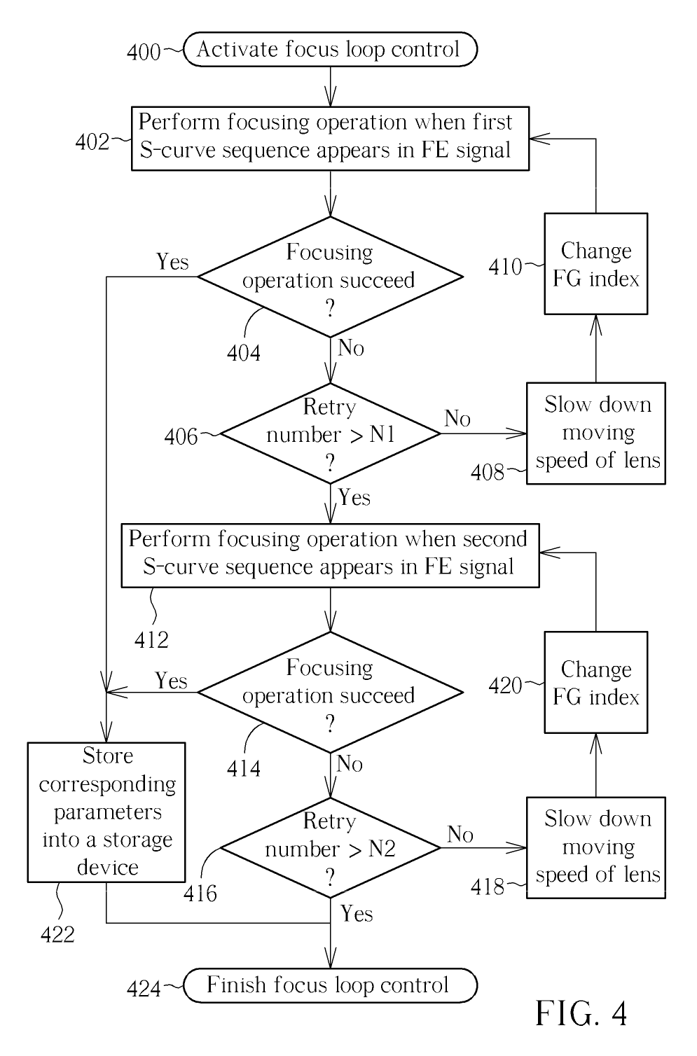

Please refer to FIG. 2, FIG. 3 and FIG. 4. FIG. 2 is a diagram illustrating a focusing operation on a disc under vertical deviation according to one embodiment of the present invention. In FIG. 2, meanings of the curve 210 and lines 220 and 230 are similar to that of the curve 110 and lines 120 and 130 in FIG. 1, respectively. FIG. 3 is a diagram illustrating a focus error (FE) signal when a focal point of a lens of an optical pick-up head is moved from the line 220 toward an optical disc. In FIG. 3, a first S-curve sequence and a second S-curve sequence respectively appear in the FE signal when the focal point of the lens is at the point E and the point F shown in FIG. 2. It is noted that, in the following description, the first S-curve sequence and its corresponding second S-curve sequence appear in the FE signal during one revolution of the optical disc. FIG. 4 is a flowchart of controlling focus loop of an optical storage device according to a first embodiment of the present invention. Please note that, the steps are not limited to be executed according to the exact order shown in FIG. 4. Besides, one or more steps may be omitted according to different requirements. Referring to the flowchart shown in FIG. 4, the operations of the focus loop control are described as follows:

In addition, a parameter “FG index” is generally for controlling a starting time that a lens of an optical pick-up head is moved from an initial position toward the optical disc, and the FG indexes corresponds to different timings of one revolution of the optical disc. In this embodiment, there are 64 FG indexed in a revolution of the optical disc. For example, referring to FIG. 1B, FG indexes of the lines 130 (from left to right) are respectively 0, 16, 32, 48 and 0. When the lens of the optical pick-up head is moved from an initial position toward the optical disc at the same FG index, a timing of the first S-curve appearing in the FE signal and the relative velocity between the lens and the disc are similar.

In Step 400, a flow of the focus loop control is activated. In Step 402, a lens of an optical pick-up head is moved from an initial position toward the optical disc at a first moving speed and at FG index=0. In this embodiment, four FG indexes are set (i.e., FG index=0, 16, 32, 48). Then, a focusing operation is performed when the first S-curve sequence appears in the FE signal. In Step 404, it is determined if a light beam generated from the optical pick-up head is focused on the optical disc or not. If the light beam is focused on the optical disc, the flow enters Step 422 to store corresponding parameters of the focusing operation into a storage device; otherwise, the flow enters Step 406. In Step 406, a value of a first retry counter for counting a number of the focusing operation is checked to see if it is greater than a first predetermined value N1. If the value of the first retry counter is less than the first predetermined value N1, the flow enters Step 408 and Step 410; otherwise, the flow enters Step 412. In Step 408 and Step 410, the lens of the optical pick-up head is moved from a current position to the initial position, the moving speed is set to be lower than the first moving speed, and the FG index is changed. Then the flow enters Step 402 and the lens is moved toward the optical disc again at a second moving speed and at FG index=16, where a maximum value of the second moving speed is less than a maximum value of the first moving speed. Repeat Steps 402-410 until the focusing operation succeeds or the value of the first retry counter is greater than the first predetermined value N1.

In Step 412, the lens is moved from the initial position toward the optical disc, and the focusing operation is not performed when a first S-curve sequence appears in the FE signal, and is performed when a second S-curve sequence appears in the FE signal. In Step 414, it is determined if the light beam generated from the optical pick-up head is focused on the optical disc or not. If the light beam is focused on the optical disc, the flow enters Step 422 to store corresponding parameters of the focusing operation into the storage device; otherwise, the flow enters Step 416. In Step 416, a value of a second retry counter for counting a number of the focusing operation is checked to see if it is greater than a second predetermined value N2. If the value of the first retry counter is less than the second predetermined value N2, the flow enters Step 418 and Step 420; otherwise, the flow enters Step 424 to finish the flow of the focus loop control. In Step 418 and Step 420, the lens of the optical pick-up head is moved from a current position to the initial position, and the moving speed is set to be lower than the previous moving speed, and the FG index is changed. Then the flow enters Step 412 and the lens is moved toward the optical disc again at a lower moving speed and at another FG index. Steps 412-420 are repeated until the focusing operation succeeds or the value of the second retry counter is greater than the second predetermined value N2.

It is noted that the Steps 408, 410, 418, 420 are optional operations; that is, in other embodiments of the present invention, focus loop control can be correctly operated without performing the above optional steps.

In addition, in Step 422, a latest FG index when the lens is moved from the initial position, a maximum moving speed of the lens during a latest movement of the lens moving from the initial position, an order of a current S-curve sequence utilized for enabling the focusing operation or a combination thereof are stored into the storage device. Furthermore, the next focus loop control may be performed according to the latest FG index, the maximum moving speed, the order of the current S-curve sequence or the combination thereof stored in the storage device. Besides, if it is determined that the light beam generated from the optical pick-up head is focused on the optical disc in Step 414, the process may proceed to Step 424 directly without performing Step 422.

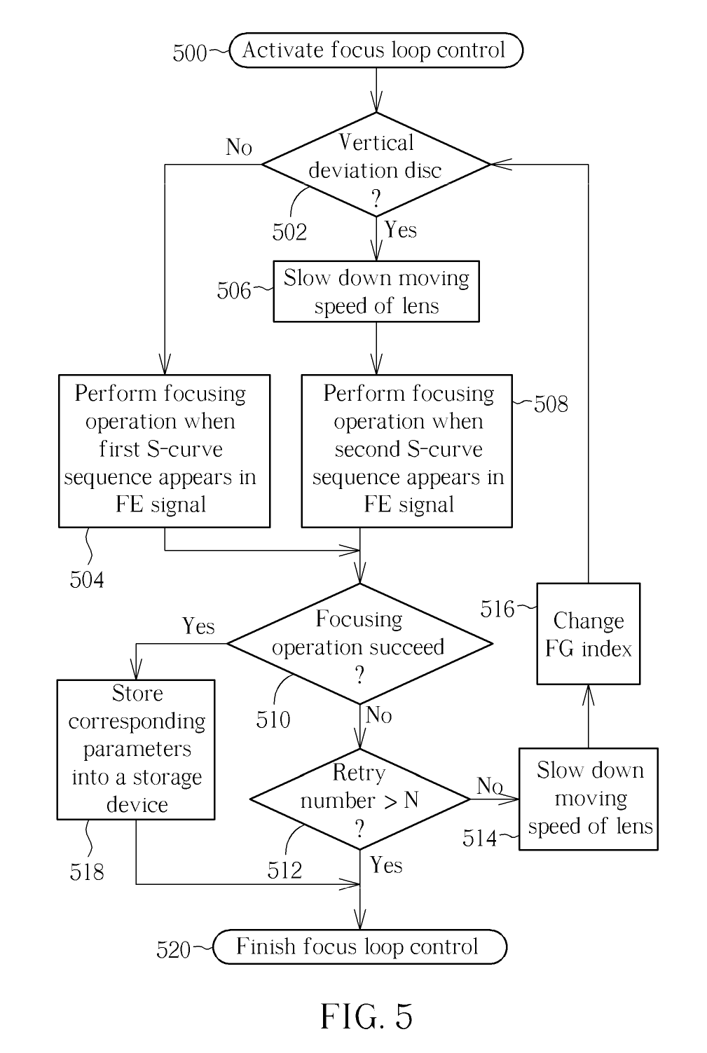

Please refer to FIG. 5 together with FIG. 2 and FIG. 3. FIG. 5 is a flowchart of controlling focus loop of an optical storage device according to a second embodiment of the present invention. Please note that, the steps are not limited to be executed according to the exact order shown in FIG. 5. Besides, one or more steps may be omitted according to different requirements. Referring to the flowchart shown in FIG. 5, the operations of the focus loop control are described as follows:

In Step 500, a flow of the focus loop control is activated. In Step 502, it is determined whether an optical disc is under vertical deviation or not. If the optical disc is not under vertical deviation, the flow enters Step 504; otherwise, the flow enters Step 506. In Step 504, a lens of an optical pick-up head is moved from an initial position toward the optical disc at a first moving speed when FG index=0, and a focusing operation is performed when a first S-curve sequence appears in the FE signal. In Step 506, the moving speed of the lens is set as a second moving speed lower than the first moving speed. In Step 508, the lens of the optical pick-up head is moved from the initial position toward the optical disc at the second moving speed when FG index=0. The focusing operation is not performed when the first S-curve sequence appears in the FE signal, and is performed when a second S-curve sequence appears in the FE signal. In Step 510, it is determined if a light beam generated from the optical pick-up head is focused on the optical disc or not. If the light beam is focused on the optical disc, the flow enters Step 518 to store corresponding parameters of the focusing operation into a storage device; otherwise, the flow enters Step 512. In Step 512, a value of a retry counter for counting a number of the focusing operation is checked to see if it is greater than a predetermined value N. If the value of the retry counter is less than the predetermined value N, the flow enters Step 514 and Step 516; otherwise, the flow enters Step 520 to finish the flow of the focus loop control. In Step 514 and 516, the lens of the optical pick-up head is moved from a current position to the initial position, the moving speed is set to be lower than a previous moving speed, and the FG index when the lens is moved is changed. Then the flow may enter Step 502 and the lens is moved toward the optical disc again at a lower moving speed and at another FG index. Steps 504-512 or Steps 508-512 may be repeated until the focusing operation succeeds or the value of the retry counter is greater than the predetermined value N.

It is noted that the Steps 502, 506, 514, 516 are optional operations; that is, in other embodiments of the present invention, focus loop control can be correctly operated without performing the above optional steps.

In addition, in Step 518, a latest FG index on the optical disc when the lens is moved from the initial position, a maximum moving speed of the lens during a latest movement of the lens moving from the initial position, an order of a current S-curve sequence utilized for enabling the focusing operation or a combination thereof are stored into the storage device. Furthermore, the next focus loop control may be performed according to the latest FG index, the maximum moving speed, the order of the current S-curve sequence or the combination thereof stored in the storage device. Besides, if it is determined that the light beam generated from the optical pick-up head is focused on the optical disc in Step 510, the process may proceed to Step 520 directly without performing Step 518.

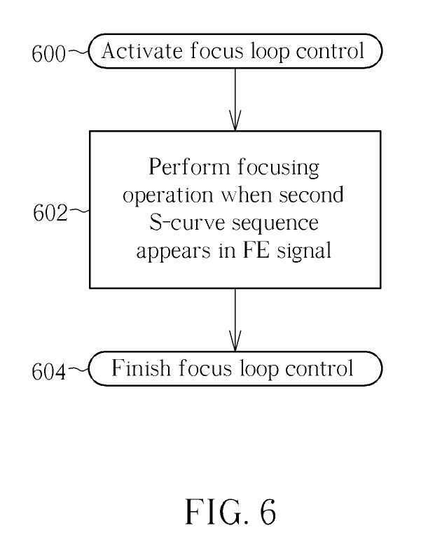

Please refer to FIG. 6 together with FIG. 2 and FIG. 3. FIG. 6 is a flowchart of controlling focus loop of an optical storage device according to a third embodiment of the present invention. Referring to the flowchart shown in FIG. 6, the operations of the focus loop control are described as follows:

In Step 600, a flow of the focus loop control is activated. In Step 602, a lens of an optical pick-up head is moved from an initial position toward an optical disc. The focusing operation is not performed when the first S-curve sequence appears in the FE signal, and is performed when a second S-curve sequence appears in the FE signal, where the first S-curve sequence appears prior to the second S-curve sequence. In Step 604, the focus loop control is finished.

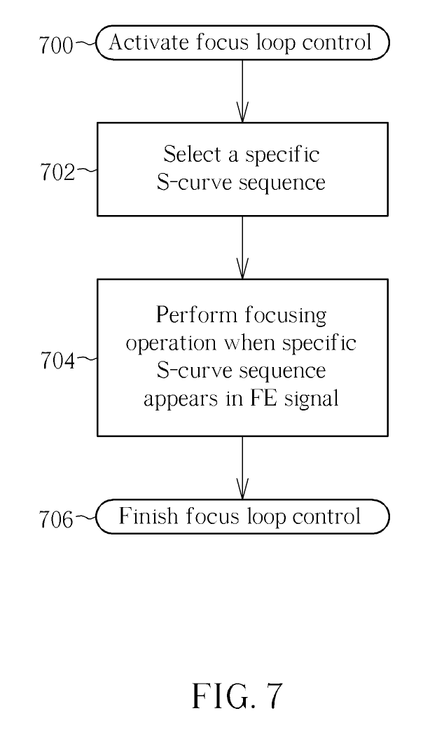

Please refer to FIG. 7 together with FIG. 2 and FIG. 3. FIG. 7 is a flowchart of controlling focus loop of an optical storage device according to a fourth embodiment of the present invention. Referring to the flowchart shown in FIG. 7, the operations of the focus loop control are described as follows:

In Step 700, a flow of the focus loop control is activated. In Step 702, a lens of an optical pick-up head is moved from an initial position toward an optical disc and a specific S-curve sequence is selected from a plurality of S-curve sequence. In Step 704, the lens is moved away from the optical disc, and then the lens is moved from the initial position toward the optical disc again. A focusing operation is then performed when the specific S-curve sequence appears in the FE signal. And in Step 706, the focus loop control is finished.

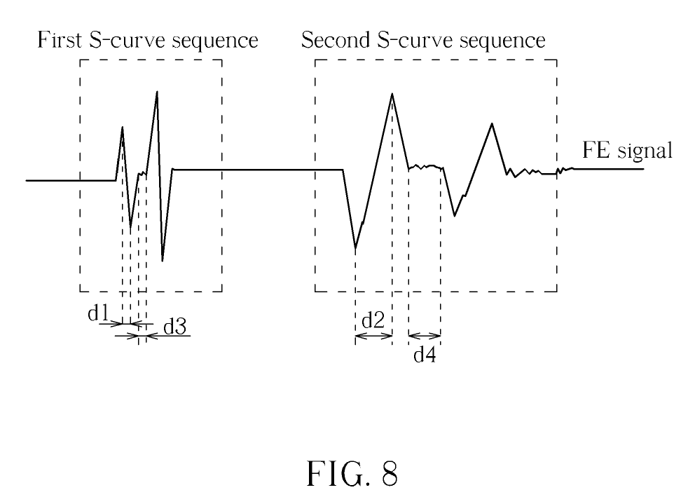

In Step 702, there may be two exemplary methods of selecting the specific S-curve sequence. FIG. 8 is a diagram illustrating S-curve sequences in the FE signal. As shown in FIG. 8, a first exemplary method is that, for each S-curve sequence, a time interval (d1, d2) respectively representing a timing difference between a positive peak and a negative peak of an S-curve in the S-curve sequence is determined, where the less the value of the time interval (d1, d2), the greater relative velocity between the lens and the disc. Then an S-curve sequence having a maximum time interval is selected as the specific S-curve sequence. For example, in FIG. 8, there are only two S-curve sequences in the FE signal and the time interval d2 is greater than time interval d1, therefore, the second S-curve sequence serves as the specific S-curve sequence.

It is noted that the definition of the time interval mentioned above is merely an example, and the time interval can also be defined as a timing difference between two ends of an S-curve.

In addition, a second exemplary method of selecting the specific S-curve sequence is that, for each S-curve sequence, a time interval (d3, d4) respectively representing a timing difference between two S-curves in the S-curve sequence is determined, where the less the value of the time interval (d3, d4), the greater relative velocity between the lens and the disc. Then an S-curve sequence having a maximum time interval is selected as the specific S-curve sequence. For example, in FIG. 8, there are only two S-curve sequences in the FE signal and the time interval d4 is greater than time interval d3, therefore, the second S-curve sequence serves as the specific S-curve sequence.

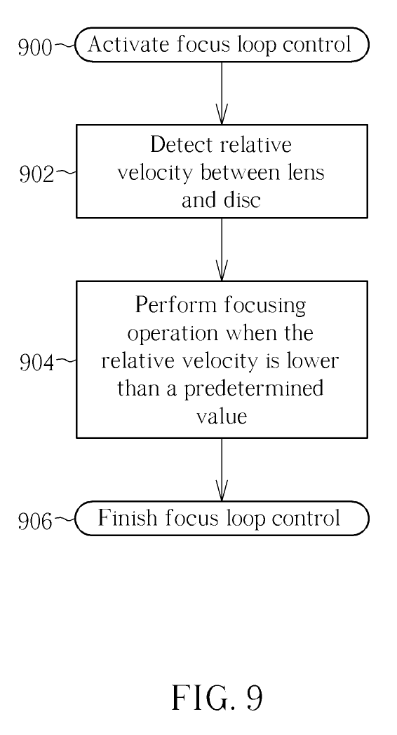

Please refer to FIG. 9 together with FIG. 2 and FIG. 3. FIG. 9 is a flowchart of controlling focus loop of an optical storage device according to a fifth embodiment of the present invention. Referring to the flowchart shown in FIG. 9, the operations of the focus loop control are described as follows:

In Step 900, a flow of the focus loop control is activated. In Step 902, a lens of an optical pick-up head is moved from an initial position toward an optical disc and a relative velocity between the lens and an optical disc is detected. In Step 904, a focusing operation is performed when the relative velocity is slower than a predetermined value and an S-curve sequence appears in a focus error signal. In Step 906, the focus loop control is finished.

Those skilled in the art will readily observe that numerous modifications and alterations of the device and method may be made while retaining the teachings of the invention.

What is claimed is:

1. A method for controlling focus loop of an optical storage device, comprising:
moving a lens of an optical pick-up head in a first moving direction;
performing a focusing operation when a first S-curve sequence appears in a focus error signal; and
when a light beam generated from the optical pick-up head is not focused on an optical disc, performing the focusing operation when a second S-curve sequence appears in the focus error signal;
wherein the first S-curve sequence and the second S-curve sequence appears in the focus error signal during one revolution of the optical disc.

2. The method of claim 1, wherein the step of moving the lens of the optical pick-up head in the first moving direction comprises:
moving the lens of the optical pick-up head from an initial position toward the optical disc.

3. The method of claim 1, wherein the step of moving the lens of the optical pick-up head in the first moving direction comprises:
moving the lens of the optical pick-up head in the first moving direction at a first moving speed;
and the method further comprises:
when the light beam is not focused on the optical disc as the focusing operation is performed when the second S-curve sequence appears in the focus error signal, moving the lens of the optical pick-up head in a second moving direction opposite to the first moving direction;
moving the lens of the optical pick-up head in the first moving direction again at a second moving speed, wherein a maximum value of the second moving speed is less than a maximum value of the first moving speed; and
performing the focusing operation when another second S-curve sequence appears in the focus error signal;
wherein the another second S-curve sequence appears in the focus error signal during another revolution of the optical disc.

4. The method of claim 1, wherein the step of moving the lens of the optical pick-up head in the first moving direction comprises:
moving the lens of the optical pick-up head from an initial position at a first FG index;
and the method further comprises:
when the light beam is not focused on the optical disc as the focusing operation is performed when the second S-curve sequence appears in the focus error signal, moving the lens of the optical pick-up head to the initial position in a second moving direction opposite to the first moving direction;
moving the lens of the optical pick-up head from the initial position in the first moving direction again at a second FG index, wherein the second FG index is different from the first FG index; and
performing the focusing operation when another second S-curve sequence appears in the focus error signal;
wherein the another second S-curve sequence appears in the focus error signal during another revolution of the optical disc.

5. The method of claim 4, further comprising:
when the light beam is focused on the optical disc, storing a latest FG index on the optical disc when the lens is moved from the initial position, a maximum moving speed of the lens during a latest movement of the lens moving from the initial position, an order of a current S-curve sequence utilized for enabling the focusing operation or a combination thereof into a storage device.

6. The method of claim 5, further comprising:
controlling the focus loop of the optical storage device according to the latest FG index, the maximum moving speed, the order of the current S-curve sequence or the combination thereof stored in the storage device.

7. A method for controlling focus loop of an optical storage device, comprising:
determining whether an optical disc is under vertical deviation or not;
moving a lens of an optical pick-up head;
when the optical disc is not under vertical deviation, performing a focusing operation when a first S-curve sequence appears in a focus error signal; and
when the optical disc is under vertical deviation, performing the focusing operation when a second S-curve sequence appears in the focus error signal, wherein the first S-curve sequence appears prior to the second S-curve sequence;
wherein the first S-curve sequence and the second S-curve sequence appear in the focus error signal during one revolution of the optical disc.

8. The method of claim 7, wherein when the optical disc is not under vertical deviation, the lens of the optical pick-up head is moved at a first moving speed; and when the optical disc is under vertical deviation, the lens of the optical pick-up head is moved at a second moving speed, where a maximum value of the second moving speed is less than a maximum value of the first moving speed.

9. The method of claim 7, further comprising:
when a light beam is not focused on the optical disc after the lens of the optical pick-up head is moved in a first moving direction at a first moving speed, moving the lens of the optical pick-up head in a second moving direction opposite to the first moving direction;
moving the lens of the optical pick-up head in the first moving direction again at a second moving speed, wherein a maximum value of the second moving speed is less than a maximum value of the first moving speed;
when the optical disc is not under vertical deviation, performing the focusing operation when another first S-curve sequence appears in the focus error signal; and
when the optical disc is under vertical deviation, performing the focusing operation when another second S-curve sequence appears in the focus error signal;
wherein the another first S-curve sequence and the another second S-curve sequence appears in the focus error signal during another revolution of the optical disc.

10. The method of claim 7, wherein the step of moving the lens of the optical pick-up head comprises:
moving the lens of the optical pick-up head from an initial position at a first FG index;
and the method further comprises:
when the light beam is not focused on the optical disc as the focusing operation is performed:
moving the lens of the optical pick-up head to the initial position in a second moving direction opposite to the first moving direction;
moving the lens of the optical pick-up head from the initial position in the first moving direction again at a second FG index, wherein the second FG index is different from the first FG index;
when the optical disc is not under vertical deviation, performing the focusing operation when another first S-curve sequence appears in the focus error signal; and
when the optical disc is under vertical deviation, performing the focusing operation when another second S-curve sequence appears in the focus error signal;
wherein the another first S-curve sequence and the another second S-curve sequence appears in the focus error signal during another revolution of the optical disc.

11. The method of claim 10, further comprising:
when the light beam is focused on the optical disc, storing a latest FG index on the optical disc when the lens is moved from the initial position, a maximum moving speed of the lens during a latest movement of the lens moving from the initial position, an order of a current S-curve sequence utilized for enabling the focusing operation or a combination thereof into a storage device.

12. The method of claim 11, further comprising:
controlling the focus loop of the optical storage device according to the latest FG index, the maximum moving speed, the order of the current S-curve sequence or the combination thereof stored in the storage device.

13. A method for controlling focus loop of an optical storage device, comprising:
moving a lens of an optical pick-up head;
not performing a focusing operation when a first S-curve sequence appears in a focus error signal; and
performing the focusing operation when a second S-curve sequence appears in the focus error signal, wherein the first S-curve sequence appears prior to the second S-curve sequence, and the first S-curve sequence and the second S-curve sequence appears in the focus error signal during one revolution of the optical disc.

14. The method of claim 13, wherein the step of moving the lens of the optical pick-up head comprises:
moving the lens of the optical pick-up head from an initial position toward the optical disc.

15. A method for controlling focus loop of an optical storage device, comprising:
moving a lens of an optical pick-up head in a first moving direction, thereby making a focus error signal having a plurality of S-curve sequences appearing therein;
selecting a specific S-curve sequence among the plurality of S-curve sequences;
moving the lens of the optical pick-up head in a second moving direction opposite to the first moving direction, and then moving the lens of the optical pick-up head in the first moving direction again; and
performing a focusing operation when the specific S-curve sequence appears in the focus error signal.

16. The method of claim 15, wherein the step of moving the lens of the optical pick-up head in the first direction comprises:
moving the lens of the optical pick-up head from an initial position toward the optical disc.

17. The method of claim 15, wherein the step of selecting the specific S-curve sequence among the plurality of S-curve sequences comprises:
for each S-curve sequence, determining a time interval between a positive peak and a negative peak of a S-curve in the S-curve sequence; and
selecting an S-curve sequence having a maximum time interval as the specific S-curve sequence.

18. The method of claim 15, wherein the step of selecting the specific S-curve sequence among the plurality of S-curve sequences comprises:
for each S-curve sequence, determining a time interval between two S-curves in the S-curve sequence; and
selecting an S-curve sequence having a maximum time interval as the specific S-curve sequence.

19. A method for controlling focus loop of an optical storage device, comprising:
moving a lens of an optical pick-up head;
detecting a relative velocity between the lens and an optical disc; and
performing a focusing operation when the relative velocity is slower than a predetermined value and an S-curve sequence appears in an focus error signal.
